(19) United States
(12) Patent Application Publication
(10) Pub. No.: US 2007/0089294 A1
(43) Pub. Date: Apr. 26, 2007

(54) Coating apparatus and die coater manufacturing method

(76) Inventor: Shigetoshi Kawabe, Tokyo (JP)

Correspondence Address: CANTOR COLBURN, LLP, 55 GRIFFIN ROAD SOUTH, BLOOMFIELD, CT, 06002, US

(21) Appl. No.: 11/638,900

(22) Filed: Dec. 14, 2006

Related U.S. Application Data
(62) Division of application No. 11/120,285, filed on May 2, 2005.

(30) Foreign Application Priority Data
May 6, 2004 (JP) JP2004-137136

(51) Int. Cl. B23P 15/06

(52) U.S. Cl. 29/888.075

(57) ABSTRACT

A coating apparatus comprising a pocket section for spreading a coating solution across the coating width, a coating solution supply port for supplying this coating solution to the pocket section, and a slit section for discharging the coating solution from the pocket section to an object to be coated, the above-mentioned coating apparatus using a die coater incorporating at least two bars. In this coating apparatus, these bars are suspended with the end face of one them facing upward. After having been heat-treated in a heat treating furnace, these bars are treated by grinding.

### CROSS REFERENCE

The present application is a divisional application of U.S. patent application Ser. No. 11/120,285, filed on May 2, 2005, the entire contents of which are incorporated herein by reference. The 11/120,285 application claimed the benefit of the date of the earlier filed Japanese Patent Application No. JP 2004-137136 filed May 6, 2004, the benefit of which is also claimed herein.

### FIELD OF THE INVENTION

The present invention relates to a coating apparatus using a die coater incorporating at least two bars and to a die coater manufacturing method. More particularly, this invention relates to a coating apparatus using a die coater incorporating at least two bars, capable of ensuring a high coating quality with a stable thickness of coated film across the coated width, and to a die coater manufacturing method.

### BACKGROUND

According to the prior art, for the surface treatment of a photographic material, heat developing/recording material, abrasion recording material, magnetic recording medium, glass plate, steel plate and others, a continuously running support member is coated with a coating solution (including undercoating treatment solution, overcoating solution and reverse side treating solution). Using the following methods, for example: Dip coating method, blade coating method, air knife coating method, wire bar coating method, gravure coating method, reverse coating method, reverse roll coating method, extrusion coating method, slide coating method, curtain coating method and others.

Of the aforementioned coating methods, the slide coating method, extrusion coating method and curtain coating method provide high speed coating, thin film coating and simultaneous multilayer coating. Consequently, these methods have been widely practiced in the case of the photographic material, heat developing/recording material, abrasion recording material and others. The coating apparatuses used in the aforementioned methods include a sliding type die coater for the sliding coating method, an extrusion type die coater for the extrusion coating method, and a curtain type die coater for the curtain coating method. In the present invention, the slide die coater and extrusion die coater are collectively called the die coater.

The die coater, for example, according to the slide coating method comprises:

a slit section, for discharging a coating solution, comprising at least two bars;

a solution pool, also called a pocket section, for supplying a coating solution uniformly across the width of the slit section; and

a lip section for coating by forming beads between the slide section to which the coating solution from the slit section flows, and the support member at the slide terminal.

Many of the coating films applied by the die coater are required to provide highly accurate thickness. This, in turn, requires the die coater to ensure a high degree of straightness. Assume, for example, that a photographic material including silver halide grains and a heat developing/recording material are coated using the slide coating method, extrusion coating method and curtain coating method. In this case, the internal stress of the members constituting the die coater or the processing stress in the production of the die coater will take effect after the lapse of a long time. This causes strain and poor straightness of the die coater. The deterioration of straightness causes an uneven gap of the slit across the coating width and an uneven distance between the die coater and object to be coated, with the result that the uniform film thickness across the coating width is deteriorated. In some cases, coating failure occurs in the prior art. To solve these problems involved in the prior art and to improve the uniformity in film thickness in the direction of coating in the die coater, attempts have been made to study the methods for machining a die coater.

The following machining method is known: As disclosed in the Official Gazette of Japanese Patent Tokkaihei 11-192452, for example, coarse machining is performed by cutting operation from the bar constituting the die coater, and the layer having been degraded by residual stress caused by coarse machining is removed by grinding. Thus, the curvature, hence, residual stress is removed. This technique provides a die coater characterized by stable slit surface accuracy over a long period of time.

However, this technique fails to solve the following problem:

1) The method of using the grinding operation to eliminate residual stress caused by coarse machining involves a huge amount to be removed by grinding. This requires excessive manpower and costs for grinding, and is not cost-effective.

2) Strain caused by stress will take effect after long-term use, with the result that straightness of the die coater deteriorates.

3) In the case of a wide die coater where the coating width exceeds 1 m, the problems given in 1) and 2) will be more serious.

As described above, in the case of a die coater having a greater coating width, uniform film thickness across the coating width cannot be obtained. This technique according to the prior art has been used only in low quality coating wherein uniform film thickness across the coating width is not required. Thus, there is an active demand for the development of a coating apparatus using a die coater and a die coater manufacturing method, wherein the die coater provides a coated product characterized by a uniform thickness of coated film across the coating width and by a great coating width of 1 m or more, with the coating failures minimized even after a long-time use.

### SUMMARY OF THE INVENTION

In view of the prior art problems described above, it is an object of the present invention to provide a coating apparatus using a die coater and a die coater manufacturing method, wherein the die coater wherein the die coater is characterized by a great coating width of 1 m or more, and is capable of manufacturing a coated product characterized by a uniform thickness of coated film across the coating width, with the coating failures minimized even after the lapse of a long time.

[Means for Solving the Problems]

The aforementioned object of the present invention can be achieved by the following configuration:

1. A coating apparatus having a die coater comprising:

a pocket section for spreading a coating solution across the coating width;

a coating solution supply port for supplying the coating solution to the pocket section; and

a slit section for discharging the coating solution from the pocket section to an object to be coated. The above-mentioned die coater incorporates at least two bars, and these bars are suspended with the end face of one of them facing upward. After having been heat-treated in a heat treating furnace, these bars are treated by grinding.

2. The coating apparatus described in the aforementioned configuration (1) wherein the aforementioned step of grinding includes the process of finish-grinding to get the final profile.

3. The coating apparatus described in the aforementioned configuration (2) wherein the aforementioned finish-grinding is carried out in such a way that the straightness across the coating width on the position constituting the slit section of the aforementioned die coater is 10 μm, when the die coater is built by incorporating bars.

4. The coating apparatus described in the aforementioned configuration (1) wherein the aforementioned heat treatment is carried out at a temperature lower than the melting point of the bar material.

5. The coating apparatus described in the aforementioned configuration (1) wherein the aforementioned bars are constituent members of the die coater. In this die coater, the gap of at least one slit section comprising at least two bars is narrower on the outlet side of the coating solution than on the inlet side, and the gap d on the outlet side is d≦5×10⁻⁵ [m]. The coating solution is jetted at a predetermined interval in the form of a film from the slit section to the support member installed or conveyed without contacting the outlet of the slit section, whereby coating is conducted by collision.

6. The coating apparatus described in the aforementioned configuration (1) wherein the aforementioned bars are constituent members of an extrusion type die coater. In this die coater, a coating solution is discharged from at least one slit section comprising at least two bars to the support member, and beads of coating solution are formed between the support member and the vicinity of the coating solution outlet of the slit, whereby coating is conducted.

7. The coating apparatus described in the aforementioned configuration (1) wherein the aforementioned bars are constituent members of a slide type die coater. In this die coater, a coating solution is discharged from at least one slit section comprising at least two bars to the support member, and the discharged coating solution is fed down the slope connected to the slit outlet. Then beads of coating solution are formed between the support member and the vicinity of the tip of the slope, whereby coating is conducted.

8. The coating apparatus described in the aforementioned configuration (1) wherein the aforementioned bars are constituent members of a curtain type die coater. In this die coater, a coating solution flowing out of at least one slit section comprising at least two bars is subjected to a free fall down to the support member, whereby coating is conducted.

9. The coating apparatus described in the aforementioned configuration (1) wherein the aforementioned bars are constituent members of the die coater having a coating width of 1 m or more.

10. The coating apparatus described in the aforementioned configuration (9) wherein the die coater has a coating width of 1 m through 4 m.

11. The coating apparatus described in the aforementioned configuration (6) wherein the support member is a belt-shaped support member whose side opposite to the coated side is held by a back roll.

12. The coating apparatus described in the aforementioned configuration (6) wherein the portions of the support member before and after the die coater are held by a support roll.

13. The coating apparatus described in the aforementioned configuration (1) wherein the coating solution is a coating solution for photosensitive layer containing the silver component for heat developing photosensitive material.

14. A method for manufacturing a die coater comprising:

a pocket section for spreading a coating solution across the coating width;

a coating solution supply port for supplying the coating solution to the pocket section; and

a slit section for discharging the coating solution from the pocket section to an object to be coated. In the aforementioned manufacturing method, the bars are suspended with the end face of one of them facing upward. After having been heat-treated in a heat treating furnace, these bars are assembled, whereby the die coater is manufactured.

15. The method for manufacturing a die coater described in the aforementioned configuration (14) wherein the aforementioned step of grinding includes the process of finish-grinding to get a final profile.

16. The method for manufacturing a die coater described in the aforementioned configuration (15) wherein the aforementioned finish-grinding is carried out in such a way that the straightness across the coating width on the position constituting the slit section is 10 μm or less, when a die coater is manufactured by assembling the bars.

17. The method for manufacturing a die coater described in the aforementioned configuration (14) wherein the aforementioned heat treatment is performed at a temperature lower than the melting point of the bar material.

18. The method for manufacturing a die coater described in the aforementioned configuration (14) wherein the aforementioned bars are constituent members of the die coater. In this die coater, the gap of at least one slit section comprising at least two bars is narrower on the outlet side of the coating solution than on the inlet side, and the gap d on the outlet side is d≦5×10⁻⁵ [m]. The coating solution is jetted at a predetermined interval in the form of a film from the slit section to the support member installed or conveyed without contacting the outlet of the slit section, whereby coating is conducted by collision.

19. The method for manufacturing a die coater described in the aforementioned configuration (14) wherein the aforementioned bars are constituent members of an extrusion type die coater. In this die coater, a coating solution is discharged from at least one slit section comprising at least two bars to the support member, and beads of coating solution are formed between the support member and the vicinity of the coating solution outlet of the slit, whereby coating is conducted.

20. The method for manufacturing a die coater described in the aforementioned configuration (14) wherein the aforementioned bars are constituent members of a slide type die coater. In this die coater, a coating solution is discharged from at least one slit section comprising at least two bars to the support member, and the discharged coating solution is fed down the slope connected to the slit outlet. Then beads of coating solution are formed between the support member and the vicinity of the tip of the slope, whereby coating is conducted.

21. The method for manufacturing a die coater described in the aforementioned configuration (14) wherein the aforementioned bars are constituent members of a curtain type die coater. In this die coater, a coating solution flowing out of at least one slit section comprising at least two bars is subjected to a free fall down to the support member, whereby coating is conducted.

22. The method for manufacturing a die coater described in the aforementioned configuration (14) wherein the aforementioned bars are constituent members of the die coater having a coating width of 1 m or more.

23. The method for manufacturing a die coater described in the aforementioned configuration (22) wherein the die coater has a coating width of 1 m through 4 m.

The present inventors have made efforts to achieve the aforementioned object, and have found out the following: When coating is performed after the lapse of a long time using the die coater having a coating width of 1 m or more, the internal stress of the bars constituting the die coater or the processing stress in the production of the bars take effect. This causes strain and poor straightness of the die coater. The deterioration of straightness causes an uneven gap of the slit across the coating width and an uneven distance between the die coater and object to be coated, with the result that the uniform film thickness across the coating width is deteriorated.

The present inventors have checked the reason for lack of uniformity in film thickness across the coating width deteriorates after the lapse of a long time, and have assumed the following phenomena occur in the step of heat treatment of the bars constituting the die coater, when the die coater is manufactured:

1) Bars are mounted horizontally on the base and the bars along with the base are placed into the heat treatment furnace wherein they are high-treated. Consequently, the straightness of the base takes effect and the curvature of the base is transferred onto the bars, with the result that straightness is adversely affected. 2) When the bars along with the base expands during the heating step and shrinks during the cooling step, difference in the amounts of expansion and shrinkage is created between the lower surface of the bars in contact with the base and the surface not in contact with the base. This causes warpage or twist, with the result that a high degree of straightness cannot be obtained. 3) When the base and lower surface of the bar is not full contact with each other, or when the bases and bars are mounted on the sleeper, the non-contact portion deflects downward due to gravity, and a high degrees of straightness cannot be ensured. Thus, grinding is performed to improve the straightness of the bars having been deteriorated by heat treatment in this manner. This step of grinding allows the stress of grinding to remain on the bars. In the die coater incorporating these bars, the grinding stress remaining on the bars takes effect after the lapse of a long time, and causes distortion throughout the die coater, whereby uniformity of the film thickness across the width of coating is adversely affected.

The present inventors have made efforts to solve this problem and have reached the present invention through the following finding: The problem can be effectively solved by minimizing the deterioration of the straightness of the bars resulting from heat treatment without being affected by the disturbance in the step of heat treatment during the production of bars constituting a die coater, and by minimizing the grinding stress and hence the grinding stress remaining on the bars.

Thus, the present invention provides a coating apparatus using a die coater and a die coater manufacturing method, wherein the die coater is characterized by a great coating width of 1 m or more, and is capable of manufacturing a coated product characterized by a uniform thickness of coated film across the coating width, with the coating failures minimized even after the lapse of a long time.

### BRIEF DESCRIPTION OF THE DRAWINGS

FIG. 1 is a schematic view of slide type coating wherein coating is performed by a slide type die coater through formation of beads;

FIG. 2 is a schematic view of extrusion coating wherein coating is performed by an extrusion type die coater through formation of beads;

FIG. 3 is a schematic view of extrusion coating wherein the support member held by a support roll is coated by the extrusion type die coater shown in FIG. 2;

FIG. 4 is a schematic view of extrusion coating wherein a coating solution is collision-coated at a predetermined interval through a slit section by another form of extrusion type die coater, without beads being formed;

FIG. 5 is s a schematic view of curtain coating by the slide type die coater given in FIG. 1;

FIG. 6 is a schematic view representing the case wherein the bars constituting the slide type die coater shown in FIG. 1 are suspended in the direction of gravity and are high-treated by a heat treatment furnace; and

FIG. 7 is a schematic view representing the case wherein the bars constituting the extrusion type die coater shown in FIG. 2 are suspended in the direction of gravity and are high-treated by a heat treatment furnace.

### BEST FORM OF EMBODIMENT OF THE PRESENT INVENTION

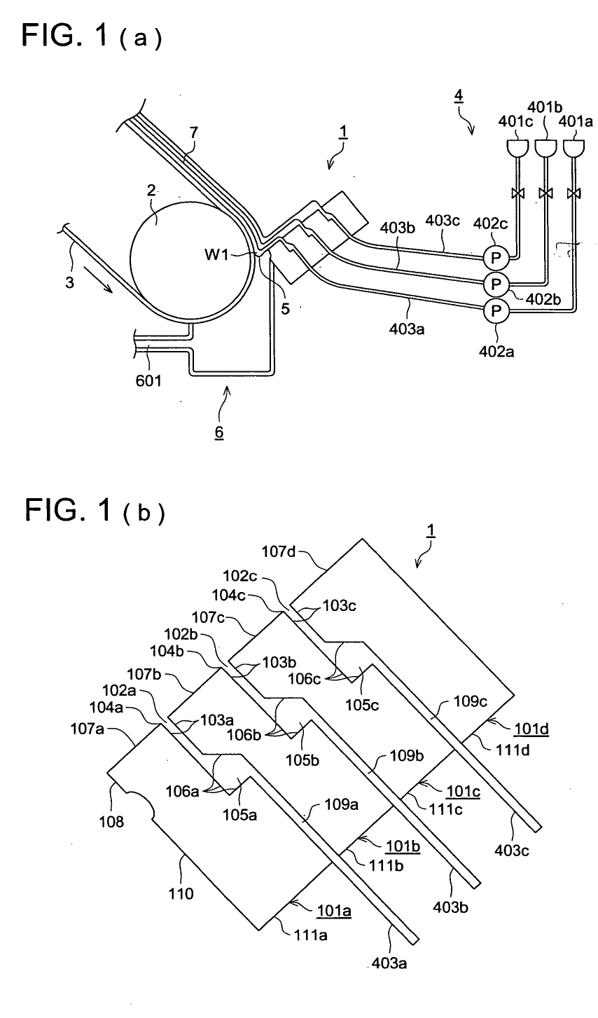

Referring to FIGS. 1 through 6, the following describes the embodiments of the present invention, without the present inventors being restricted thereto:

FIG. 1 is a schematic view of slide type coating wherein coating is performed by a slide type die coater through formation of beads. FIG. 1(a) is a schematic view of slide coating wherein the slide type die coater is used for coating on the support section of the support member whose side opposite to the coated side is held by a back roll, through formation of beads. FIG. 1(b) is an enlarged schematic view of the slide type die coater given in FIG. 1.

Numeral 1 in the drawing denotes a slide type die coater, 2 a back roll and 3 a belt-shaped support member continuously fed from upstream to downstream (arrow-marked direction in the drawing). Numerals 101a through 101d indicate members constituting the coater. The number of bars are not fixed; it can be adjusted according to the number of the layers to be coated. The back roll indicates the conveyance roll installed on the side opposite to the coated side of the belt-shaped support member 3, with the slide type die coater 1 and belt-shaped support member 3 sandwiched in-between. As in the case of the slide type die coater 1, the cylindricity has a serious impact upon the accuracy of the gap across the coating width. Consequently, it is made of a metal having a large diameter of 200 mm or more.

Numerals 102a through 102c indicate slit sections as outlets of coating solution formed between bars constituting the slide type die coater. The number of the slit sections varies according to the number of the bars constituting the slide type die coater. Normally, 2 through 20 slit sections are provided. The slide type die coater given in this drawing comprises four bars, and refers to a slide type die coater, for simultaneous multilayer, having three slit sections.

Numerals 103a through 103c indicate the inner wall of the slit sections 102a through 102c. Numerals 104a through 104c indicate the edges of the outlets of slit sections 102a through 102c. Numerals 105a through 105c indicate the pocket sections, provided on the slit sections 102a through 102c, for uniform pushing out of the coating solution fed from supply tubes 403a through 403c, across the width from the slit sections 102a through 102c. Numerals 106a through 106c indicate the inner walls of the pocket sections 105a through 105c.

Numerals 107a through 107d indicate the slide surfaces. The coating solution prepared by preparing kilns 401a through 401c of a coating solution supply system 4 is supplied to the solution pools 105a through 105c created among bars 101a through 101d by solution feed pumps 402a through 402c via the supply tubes 403a through 403c. The coating solution pushed out of the slit sections 102a through 102c flows down slide surfaces 107a through 107c, and forms beads 5 through a lip section 108. The beads 5 are coated on the support section of the support member 3, which is transported with its side opposite to the coated side being held by the back roll 2.

Numeral 110 indicates the outer wall connected to the lip section 108. Numerals 109a through 109c represent the coating solution supply paths for supplying the solution pools 105a through 105c with the coating solution fed from the supply tubes 403a through 403c.

Numerals 111a through 111d indicate the reverse sides of the bars 101a through 101d opposite to the slide surfaces 107a through 107d. These reverse sides 111a through 111d form the reverse sides of the slide type die coater 1.

Numeral 6 denotes a decompression chamber arranged on the lower portion of the slide type die coater 1, and 601 shows a suction tube. Numeral 7 shows the layer coated on the support member. W1 indicates the point where coating solution is applied to the support member 3 by the slide type die coater 1. This point is preferably located 0 through 20 degrees below the horizontal axis passing through the center of the back roll.

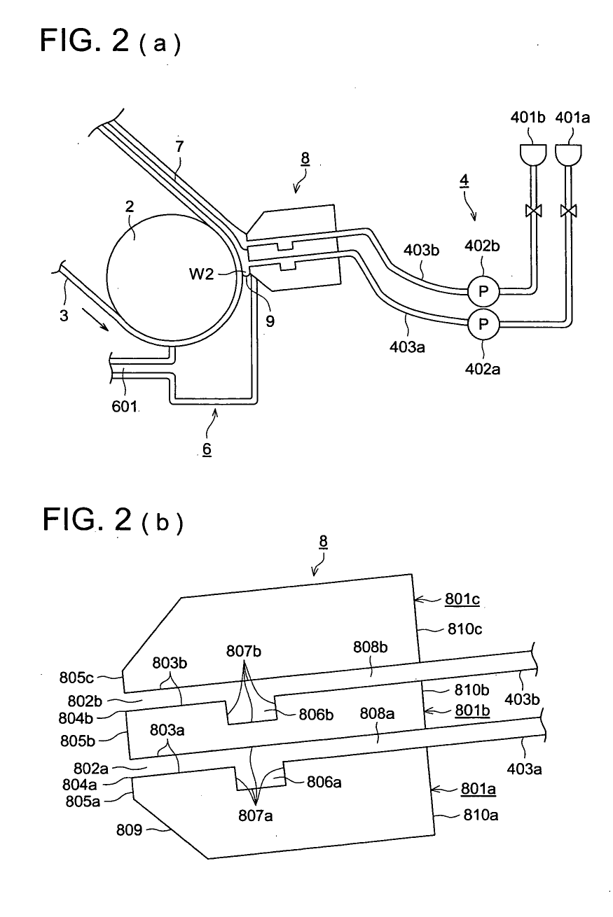

FIG. 2 is a schematic view of extrusion coating wherein coating is performed by an extrusion type die coater through formation of beads. FIG. 2(a) is a schematic view of extrusion coating wherein the extrusion type die coater is used for coating on the support section of the support member whose side opposite to the coated side is held by a back roll, through formation of beads. FIG. 2(b) is an enlarged schematic view of the extrusion type die coater given in FIG. 2(a).

Numeral 8 in the drawing denotes an extrusion type die coater, and 801a through 801c show the bars constituting the extrusion type die coater 8. The number of bars are not fixed; it can be adjusted according to the number of the layers to be coated.

Numerals 802a and 802b indicate the slit sections as outlets of coating solution created among the bars 801a through 801c constituting the extrusion type die coater 8. The number of the slit sections varies according to the number of the bars constituting the extrusion type die coater. Normally, 1 through 5 slit sections are provided. The extrusion type die coater given in this drawing comprises three bars, and refers to an extrusion type die coater, for simultaneous multilayer, having two slit sections.

Numerals 803a and 803b indicate the inner walls of slit portions 802a and 802b, and 804a and 804b indicate the edges of the outlets of the slit portions 802a and 802b. Numerals 805a and 805c denote the lip sections, and 806a and 806b indicate the pocket sections provided on the slit portions 802a and 802b in order to ensure uniform pushing out of the coating solution fed from the supply tubes 403a and 403b, through the slit portions 802a and 802b across the width. Numerals 807a and 807b show the inner walls of the pocket sections 806a and 806b.

Numerals 808a and 808b denote the coating solution supply path to supply the 806a and 806b with the coating solution fed from the supply tubes 403a and 403b. Numeral 809 indicates an outer wall communicating with the lip section 805a.

Numerals 810a though 810c show the reverse side of the bars 801a through 801c located opposite to the lip sections 805a through 805c. The reverse sides 810a through 810c form the reverse side of the extrusion type die coater 8.

The coating solution prepared by the preparing kilns 401a and 401b is fed to the pocket sections 806a and 806b provided on the bars 801a through 801c, through the supply tubes 403a and 403b by the solution feed pumps 402a and 402b. The coating solution having been pushed out of the slit portions 802a and 802b forms beads 9 through the lip section 805a, and is applied to the section for holding the belt-shaped support member 3, which is transported with its side opposite to the coated side being held by the back roll 2. Symbol W2 indicates the point for coating the support member 3 with the coating solution by the coater 8. Normally, this point is preferably located 0 through 90 degrees below the horizontal axis passing through the center of the back roll. Other reference numerals can be defined in the same manner as those of FIG. 1.

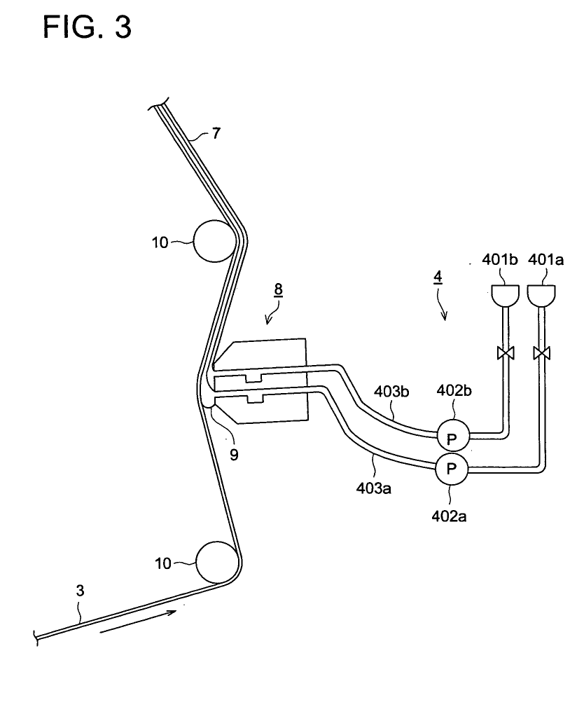

FIG. 3 is a schematic view of extrusion coating wherein the support member held by a support roll is coated by the extrusion type die coater shown in FIG. 2.

In FIG. 3, 10 shows a support roll. This drawing shows the method of coating wherein the support member is supported by the two support rolls arranged on the upstream and downstream sides of the extrusion type die coater 8, instead of the back roll, as shown in FIG. 2. Other numerals can be defined in the same manner as those of FIG. 2.

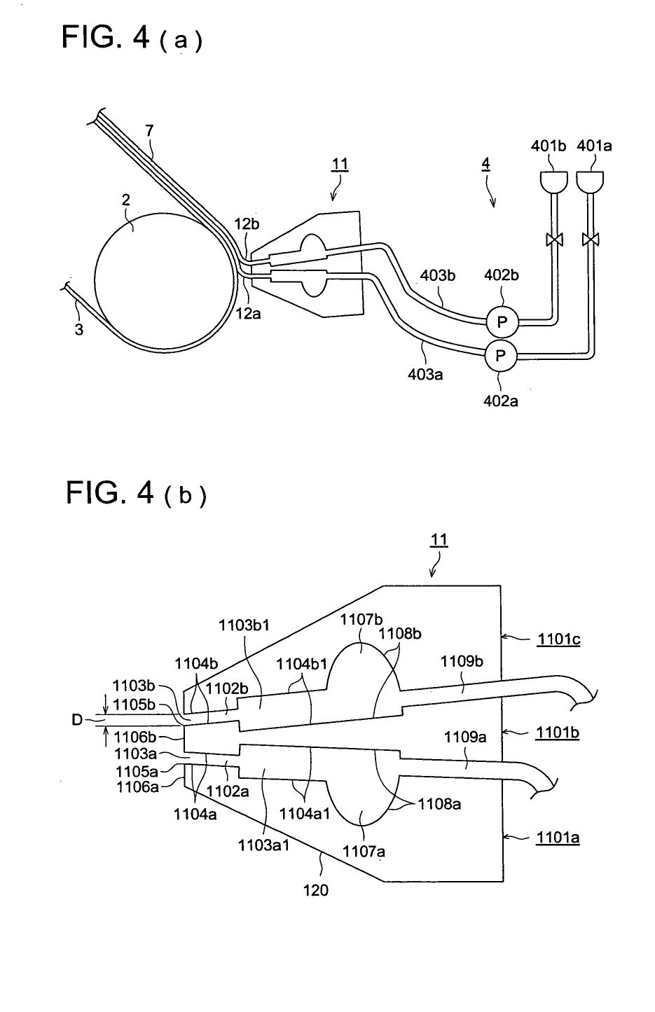

FIG. 4 is a schematic view of extrusion coating wherein a coating solution is collision-coated at a predetermined interval through a slit section by another form of extrusion type die coater, without beads being formed. FIG. 4(a) is a schematic view of extrusion coating wherein a coating solution is applied to the support section of the support member 3 with its side opposite to the coated side being held by the back roll. In this case, the coating solution is applied by another form of extrusion type die coater, without beads being formed. FIG. 4(b) is an enlarged schematic view of the extrusion type die coater shown in FIG. 4(a).

In the drawing, 11 indicates an extrusion type die coater, and 1101a through 1101c indicate bars constituting the coater. The number of bars are not fixed; it can be adjusted according to the number of the layers to be coated.

Numerals 1102a through 1102b indicate the slit section formed among bars 1101a through 1101c, which are provided between the bars constituting the extrusion type die coater. Numerals 12a and 12b indicate the coating films formed by the coating solution jetted from slit sections (1102a and 1102b.

The number of the slit sections varies according to the number of the bars constituting the extrusion type die coater. Normally, 1 through 5 slit sections are provided. The extrusion type die coater given in this drawing comprises three bars, and refers to an extrusion type die coater, for simultaneous multilayer, having two slit sections.

Numerals 1103a and 1103b denote the coating solution outlets of the slit sections 1102a and 1102b, and 1103a1 and 1103b1 indicate the coating solution inlets. Numerals 1104a and 1104b show the inner walls of the outlets 1103a and 1103b of coating solution of the slit sections 1102a and 1102b, and 1104a1 and 1104b1 denote the inner walls of the inlets 1103a1 and 1103b1 of coating solution. Numerals 1105a and 1105b represent the edges of the slit sections 1102a and 1102b, and 1106a and 1106b denote the lip sections. Numerals 1107a and 1107b represent the indicate the solution pools, provided on the slit sections, for uniform pushing out of the coating solution fed from supply tubes 403a and 403b, across the width from the slit sections 1102a through 1102b. Numerals 1108a and 1108b indicate the inner walls of the solution pools 1107a and 1107b.

Numerals 1109a and 1109b represent the coating solution supply paths for supplying the solution pools 1107a and 1107b with the coating solution fed from the supply tubes 403a and 403b. Numeral 120 indicates an outer wall communicating with the lip section 1106a.

The coating solution prepared by preparing kilns 401a and 401b of the coating solution supply system 4 is supplied to the solution pools 1107a and 1107b provided among the bars 1101a through 1101c, through the solution feed pumps 402a and 402b. The coating solution jetted like a film from the slit sections 1102a and 1102b is collision-coated on the section for holding the support member 3, which is transported with its side opposite to the coated side being held by the back roll 2. “ID” indicates the outlet gap of the slit section. The outlet gap D can be adjusted adequately according to the thickness of the coating film. The gap of the slit section is designed in such a way that the coating solution inlet side is wide, and outlet side is narrow, with the outlet gap D defined as D≦5×10⁻⁵ [m], or preferably as 1×10⁻⁵ [m]≦D≦4×10⁻⁵ [m]. If the D is kept within this range, coating solution can be jetted out as an extremely thin film as compared to the case of the conventional extrusion type die coater. Thus, coating of thin film can be achieved.

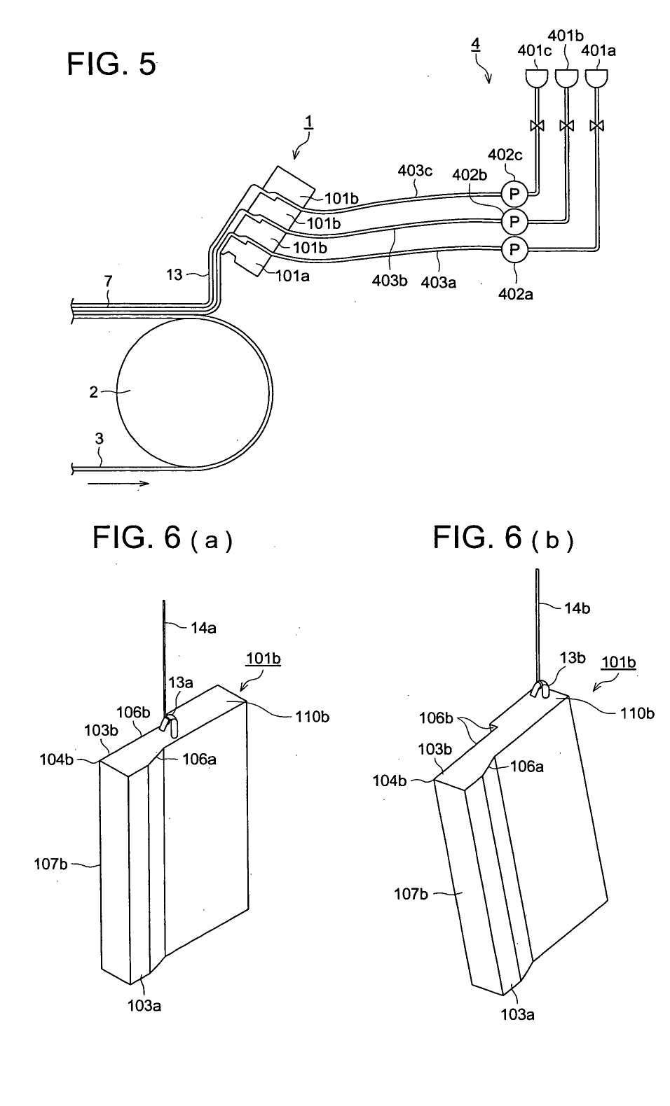

FIG. 5 is s a schematic view of curtain coating by the slide type die coater given in FIG. 1.

In the drawing, 13 denotes the film formed by gravity drop of coating solutions, pushed out of slit sections in a form placed one on top of another, flowing down the slide surface. This film 13 is applied to the support member.

In various types of die coaters shown in FIGS. 1 through 5, the pocket section is designed to have a large cross section for a lower flow rate in such a way that the coating solution can be spread evenly under uniform pressure across the width of coating, and uniform coating solution is fed out of the slit. For this purpose, keeping a constant straightness of the pocket section and slit section is effective in ensuring a stable thickness of the coating film across the width of coating.

The lip section allows the coating solution flowing out of the slit to form beads once between the support members and die coater, and permits the coating solution to coat the support member. In the slide type die coater and extrusion type die coater shown in FIGS. 1 through 3, if the straightness of the lip section is poor, the beads will be instable and the thickness of the coating film across the width of coating will be instable. In this sense, keeping a constant straightness of the lip section is effective in ensuring a stable thickness of the coating film across the width of coating.

The edge is capable of ensuring stable flowing of the coating solution. If the straightness of the edge is poor, the discharge of the coating solution from the slit will be instable, and the thickness of the coating film across the width of coating will also be instable. In this sense, keeping a constant straightness of the lip section and slit section is effective in ensuring a stable thickness of the coating film across the width of coating.

In the case of the slide type die coater shown in FIGS. 1 and 5, the slide surface allows downward flow of the coating solution discharged from the slit. If the straightness of the slide surface is poor, uniform thickness of the coating solution cannot be maintained when the coating solution flows down the slide surface. Consequently, the thickness of the coating film across the width of coating will be instable. Thus, keeping a constant straightness of the slide surface is effective in ensuring a stable thickness of the coating film across the width of coating.

The present invention relates to a coating apparatus and die coater manufacturing method wherein the die coater comprises:

a pocket section for spreading a coating solution across the coating width as described above;

a coating solution supply port for supplying the coating solution to the pocket section; and

a slit section for discharging the coating solution from the pocket section to an object to be coated. The above-mentioned die coater incorporates at least two bars, and these bars constituting the die coater is characterized by a constant straightness. The following describes the method of manufacturing the die coater of the present invention:

FIG. 6 is a schematic view representing the case wherein the bars constituting the slide type die coater shown in FIG. 1 are suspended in the direction of gravity and are high-treated by a heat treatment furnace. FIG. 6(a) is a schematic view showing the case wherein the bars constituting the slide type die coater shown in FIG. 1 are suspended with the end face of one of the bars facing upward, and are high-treated by a heat treatment furnace. FIG. 6(b) is a schematic view showing the case wherein the bars constituting the slide type die coater shown in FIG. 1 are suspended at a different fulcrum, with the end face of the other of the bars facing upward, and are high-treated by a heat treatment furnace. In this drawing, the heat treatment furnace is not illustrated.

In the drawing, 13a denotes a suspending jig mounted at almost the center of the end face 110b (a portion forming the lateral face of the die coater when bars are assembled to build a die coater) of the bars 101b. Numeral 14a shows a member for suspending the bar 101b through the jig 13a. Numeral 13b represents the suspending jig mounted on the end of the end face 110b of the bar 101b. Numeral 14b shows the suspending member for suspending the bar 101b through the jib 13b.

There is no restriction on the members 14a and 14b if they can stand the mass of the bars. For example, a steel chain or wire can be used. This drawing shows the case where a wire is utilized. Other reference numerals can be defined in the same manner as those of FIG. 1.

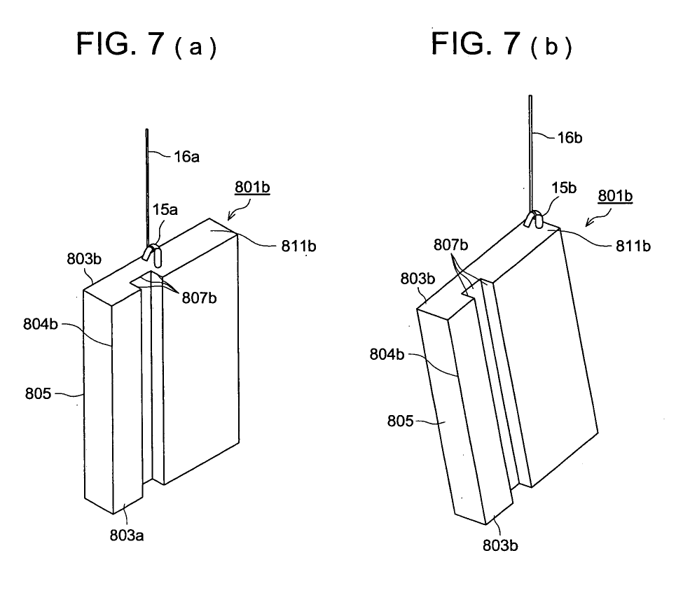

FIG. 7 is a schematic view representing the case wherein the bars constituting the extrusion type die coater shown in FIG. 2 are suspended in the direction of gravity and are high-treated by a heat treatment furnace. FIG. 7(a) is a schematic view representing the case wherein the bars constituting the extrusion type die coater shown in FIG. 2 are suspended with the end face of one of the bars facing upward, and are high-treated by a heat treatment furnace.

FIG. 7(b) is a schematic view representing the case wherein the bars constituting the extrusion type die coater shown in FIG. 2 are suspended at a different fulcrum, with the end face of the other of the bars facing upward, and are high-treated by a heat treatment furnace. In this drawing, the heat treatment furnace is not illustrated.

In the drawing, 15a denotes a suspending jig mounted at almost the center of the end face 811b (a portion forming the lateral face of the die coater when bars are assembled to build a die coater) of the bars 801b. Numeral 16a shows a member for suspending the bar 801b through the jig 15a. Numeral 15b represents the suspending jig mounted on the end of the end face 811b of the bar 801b. Numeral 16b shows the suspending member for suspending the bar 801b through the jib 15b.

There is no restriction on the members 16a and 16b if they can stand the mass of the bars. For example, a steel chain or wire can be used. This drawing shows the case where a wire is utilized. Other reference numerals can be defined in the same manner as those of FIG. 2.

The jig for suspending the bars as shown in FIGS. 6 and 7 can be mounted at any position if the flow of the coating solution is not adversely affected when the bars are assembled to build a die coater. This drawing shows the case wherein the jig is mounted on the end face of the bars constituting the lateral face of the die coater to suspend the bars, when the bars are assembled to build a die coater.

The suspending jig can be mounted at any position. However, it is preferred that the direction of gravity lie on the long side, viz., across the width of coating because this arrangement ensures stability.

The bars constituting the die coater are suspended when they are high-treated by a heat treatment furnace. This arrangement allows the bars to be heated and cooled without the bars coming into contact with other solids located nearby. This will ensure uniform expansion and shrinkage of all the surfaces of the bars, and will eliminates the possibility of causing warpage or twist. Force is applied in such a way that, if there is a curvature, the bars are pulled straight by gravity, with the result that the curvature of the bars is improved. This will provide bars characterized by superb straightness. As a result, the amount of grinding work is reduced in the step of grinding subsequent to heat treatment, and therefore the residual amount of grinding stress is be reduced. The bars produced in this manner are assembled to produce the die coater. Such a die coater is impervious to any variation in the straightness that may adversely affect the property of coating after the lapse of a long time. Thus, stable coating is ensured. In particular, this arrangement reduces the strain of the die coater having a great width of 1 m or more, wherein reduction of the strain has been difficult when the prior art is used. The drawing shows the die coater having a preferable coating width of 1 through 4 m.

The following describes an example of the method for manufacturing the die coater of the present invention: In this method, the die coater of the present invention is manufactured according to the first to third steps shown below.

In the first step, bars constituting the die coater are suspended in the direction of gravity and are subjected to heat treatment.

In the second step, strain caused in the first step is removed by grinding.

In the third step, the bars obtained in the second step are assembled to produce a die coater.

The temperature of heat treatment in the first step is differs according to the material of the bars constituting the die coater, and its value cannot be determined easily. The upper limit of the temperature is preferably lower than the melting point of the material. There is no restriction to the material of the bars used in the present invention; precipitation hardening stainless steel can be used, for example.

The second grinding step contains the following two processes: One is the first grinding process where strain is removed by heat treatment. The other is the second grinding process where the material is finished to conform to the profile and straightness specified in an intended design drawing, subsequent to the first printing process.

The straightness of the bars subsequent to the second grinding is 10 μm or less. If it exceeds 10 μm, a stable supply of coating solution will be difficult, and the stable thickness of the coating film cannot be obtained. Such a problem must be solved.

Straightness refers to the straightness of the bar surface across the width of coating. A bar is placed on a precision surface grinder. The probe of a dial gauge in contact with the measuring point of the bar is fixed, and the surface grinder is moved, whereby measurements area recorded. Grinding can be performed by a commonly utilized precision surface grinder. The method of manufacturing the die coater of the present invention is effective in producing a die coater having a coating width of 1 m or more, or preferably 1 through 4 m. A die coater can be obtained by the aforementioned first through third steps.

There is no restriction to the material of the support member used in the present invention if the support member is belt-shaped and transportable. For example, paper, plastic film and metallic sheet can be used. Paper that can be used includes resin coated paper and synthetic paper. The plastic film that can be used includes polyolefin film (e.g. polyethylene film and polypropylene film), polyester film (e.g. polyethylene terephthalate film and polyethylene 2, 6-naphthalate film), polyamide film (e.g. polyether ketone film) and cellulose acetate (e.g. cellulose triacetate). The metallic sheet typically includes an aluminum sheet. Further, there is no restriction to the thickness of the support member to be used.

There is no restriction to the coating solution to be used in the present invention. For example, it is possible to use the coating solutions (coating solutions for undercoating and overcoating, reverse layer solution, etc.) for a photographic material, heat developing/recording material, abrasion recording material, magnetic recording medium, steel plate surface treatment and electro-photoconductor. Of these solutions, preferable ones are silver-containing coating solution for photosensitive layer as a coating solution for heat development photosensitive material, and coating solution for non-photosensitive protective layer.

### EXAMPLES

The following provides a specific description of the advantages of the present invention with reference to examples, without the prevent invention being restricted thereto:

### Example 1

A photosensitive layer coating solution containing organic silver and a surface protective layer coating solution were prepared according to the following methods:

<Photosensitive Layer Coating Solution>

<<Preparation of Halogenated Emulsion A>>

7.5 g of inert gelatine and 10 mg of potassium were dissolved in 900 ml of water, and the temperature and pH value were set to 35 degrees Celsius and 3.0, respectively. Then 370 ml of aqueous solution containing 74 g of silver nitrate, and (2) 370 ml of aqueous solution containing 1×10⁻⁶ mol per mole of silver of potassium bromide and potassium iodine having a mole ratio of (98/2) and the [Ir (NO) C15] salt and 1×10⁻⁶ mol per mole of silver of rhodium chloride salt were added according to the controlled double jet method, with the pAg value kept at 7.7. After that, 4-hydroxy-6-methyl-1,3,3, a and 7-tetrazainden were added and NaOH was used to adjust the pH value to 5. This arrangement produced a cubic silver iodobromide grain having an average grain diameter of the 0.06 μm, a degree of monodispersion of 10%, a variation coefficient of the projected diameter area of 8%, and [100] area ratio of 87%. Using a gelatine coagulant, this emulsion was subjected to coagulation and precipitation, and was desalinated. Then 0.1 g of phenoxyethanol was added for adjustment to get a pH value of 5.9 and a pAg value of 7.5, whereby silver halide emulsion was obtained. Further, the silver halide emulsion obtained in this manner was subjected to chemical sensitization by chloroauric acid and inorganic sulfur, whereby silver halide emulsion A was obtained.

The aforementioned degree of monodispersion and projected diameter area variation coefficient were calculated by the following formula:

Degree of monodispersion (%)=(grain size standard deviation)/(grain size average value)×100

Projected diameter area variation coefficient (%)=projected diameter area standard deviation)/(projected diameter area average value)

<<Preparation of Aqueous Solution of Sodium Behenate>>

32.4 g of behenic acid, 9.9 g of arachidic acid and 5.6 g of strearic acid were dissolved in 945 ml of pure water at a temperature of 90 degrees Celsius. During high speed agitation, 98 ml of 1.5 mol/L aqueous solution of sodium hydroxide was added to it. Then 0.93 ml of concentrated nitric acid was added. After being cooled down to 55 degrees Celsius, it was stirred for 30 minutes, whereby aqueous solution of sodium behenate was obtained.

(Preparation of Preformed Emulsion)

15.1 g of the aforementioned silver halide emulsion A was added to the aforementioned aqueous solution of sodium behenat, and solution of sodium hydroxide was used to adjust the pH value to 8.1. Then 147 ml of 1 mol/L of silver nitrate solution was added gradually over the period of 7 minutes. After 20-minute stirring, water soluble salts were removed by ultrafiltration. The silver behenate obtained in this way was made up of grains having an average grain diameter of the 0.8 μm and a degree of monodispersion of 8%. After formation of a flock as dispersion, water was removed. After further six steps of washing and dewatering, it was dried. Then 544 g of methyl ethyl ketone solution (17 percent by mass) of polyvinyl butyral (average molecular weight: 3000) and 107 g of toluene were gradually added and mixed. Then a medium homogenizer was used for dispersion at 27.6 MPa, whereby preformed emulsion was prepared.

<Preparation of Photosensitive Layer Coating Solution>

| | | |
|---|---|---|
| Preformed emulsion | 240 | g |
| Sensitizing dye-1 (0.1% methanol solution) | 1.7 | ml |
| Pyridinium bromide perbromide (6% methanol solution) | 3 | ml |
| Potassium bromide (0.1% methanol solution) | 1.7 | ml |
| Anti-fogging agent-1 (10% methanol solution) | 1.2 | ml |
| 2-(4-chlorobenzoyl benzoic acid (12% methanol solution) | 9.2 | ml |
| 2-mercaptobenzimidazole (1% methanol solution) | 11 | ml |
| Tribromomethyl sulfoquinoline (5% methanol solution) | 17 | ml |
| Developer-1 (20% methanol solution) | 29.5 | ml |

Sensitizing dye-1

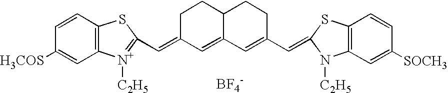

Anti-fogging agent-1

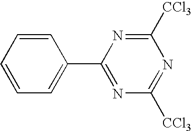

Developer-1

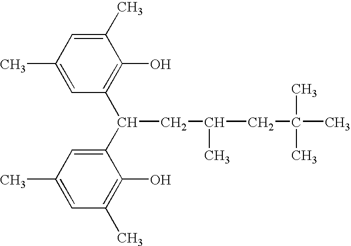

(Surface Protective Coating Solution)

<<Preparation of Surface Protective Coating Solution>>

| | | |
|---|---|---|
| Acetone | 35 | ml/m² |
| Methyethyl ketone | 17 | ml/m² |
| Cellulose acetate | 2.3 | g/m² |
| Methanol | 7 | ml/m² |
| Phthalazine | 250 | mg/m² |
| 4-methylphthalic acid | 180 | mg/m² |
| Tetrachlorophthalic acid | 150 | mg/m² |
| Tetrachlorophthalic acid anhydride | 170 | mg/m² |
| Matting agent: degree of monodispersion: 10%; average | 70 | mg/m² |
| grain diameter: 4 μm; monodisperse silica) | | |
| C₉H₁₉—C₆H₄—SO₃Na | 10 | mg/m² |

<Production of Die Coater>

The slide type die coaters shown in FIG. 1 were manufactured according to the following method, and were assigned with “1-1 and 1-2”. The bars, made of stainless steel (SUS 630) constituting the slide type die coater, each having a length of 2,000 mm on the long side are suspended as shown in FIG. 6, and were high-treated. Subsequent to the first grinding step for removing strain resulting from heat treatment, the bars were subjected to second grinding where they were finished into a final profile, whereby a slide type die coater was manufactured by assembling. Grinding was conducted under the same conditions, except that heat treatment was conducted with the bars placed on the base (upright on the base, with the reverse side of the slide type die coater facing downward), instead of being suspended. Another slide type die coater was manufactured by assembling. This is assigned with 1-3 for comparison.

Heat treatment in the heat treatment furnace was carried out at a temperature of 400 degrees Celsius for five hours. In the second grinding step, the bar was assembled to manufacture a slide type die coater. In this case, the straightness of the portion of the bar constituting the pocket section, coating solution supply port, slit section, edge, lip and slide surface was 1 μm, with a surface roughness Ra of 1 μm and Rmax of 0.5 μm. In the first and second grinding steps, a column type precision surface grinding machine by Okamoto Machine Tool Works, Ltd. was used. To measure the straightness, the bar was placed on the surface grinding machine, and the surface grinding machine was moved, with the probe of the dial gauge fixed in contact with the measuring point of the bar, whereby the straightness was measured. The surface roughness Ra and Rmax were measured by Model Surtest SJ-201P of Mitsutoyo Co., Ltd.

TABLE 1

| Slide die | Position of bars | |
|---|---|---|
| coater No. | during heat treatment | Remarks |
| 1-1 | Suspended as shown in FIG. 6 (a) | Present |
| | | invention |
| 1-2 | Suspended as shown in FIG. 6 (b) | Present |
| | | invention |
| 1-3 | Placed on the base | Comparison |

<Coating>

The viscosity of the photosensitive layer coating solution prepared in the aforementioned steps was adjusted to 0.5 Pa·s, and the viscosity of the surface protective layer was adjusted to 1.0 Pa·s. Ten belt-shaped support members (made of PET), each having a thickness of 175 μm, a width of 2100 mm and a length of 1,000 mm, were connected with one another. In a coating apparatus equipped with the slide type die coaters 1-1, 1-2 and 1-3 having been just produced, the belt-shaped support member held by the back roll was coated and dried under the conditions of a coating width of 1900 mm at a coating speed of 30 m/min, wherein the lower layer was provided with 75 g/m² of photosensitive layer, and the upper layer was provided with 25 g/m² of protective layer. Then samples 101 through 103 were produced. In another coating apparatus equipped with slide type die coaters 1-1 through 1-3 having been used for one year, the belt-shaped support member held by the back roll was coated and dried under the conditions of a coating width of 1900 mm at a coating speed of 30 m/min, wherein the lower layer was provided with 75 g/m² of photosensitive layer, and the upper layer was provided with 25 g/m² of protective layer. Then samples 104 through 106 were produced. Viscosity was obtained by measuring the viscosity for each shearing, using Model RotoVisco RV-12 by HAAKE Inc. The photosensitive layer coating solution and surface protective layer coating solution were coated at a normal temperature.

<Evaluation>

The samples 101 through 106 having been produced in the aforementioned steps were tested to measure the crosswise distribution of coating film thickness. Table 2 shows the result of this measurement. The distribution of the coating film thickness across the width was evaluated according to the following criteria. To check crosswise distribution of coating film thickness, thickness of coating was measured at intervals of 50 mm across the width of coating 100 m from the end of coating, and the ratio of the difference between the maximum and minimum values relative to the average value was obtained by calculation. This result was represented in percentage. To check the thickness of the coating film, a point of the sample along with the support member was measured by the Electric Micrometer MINICOM M made by Tokyo Seimitsu Co., Ltd., and the coated surface of the same site was wiped clean with non-woven fabric impregnated with methyl ethyl ketone. Then the thickness of the support member was measured and the difference of the measurements was taken as the thickness of the coating film. Evaluation criteria of the crosswise distribution of coating film thickness

A. Crosswise distribution of coating film thickness: 0.1 through 1.0% exclusive

B. Crosswise distribution of coating film thickness: 1.0 through 2.5% exclusive

C. Crosswise distribution of coating film thickness: 2.5 through 5.0% exclusive

D. Crosswise distribution of coating film thickness: 5.1% or more

TABLE 2

| | Crosswise distribution | | |
|---|---|---|---|
| Slide type | of coating film thickness | | |
| die coater | Immediately after | After one-year | |
| No. | production | use | Remarks |
| 1-1 | Sample No. 101 | Sample No. 104 | Present |
| | A | A | invention |
| 1-2 | Sample No. 102 | Sample No. 105 | Present |
| | A | B | invention |
| 1-3 | Sample No. 103 | Sample No. 106 | Comparison |
| | A | D | |

In the slide type die coater 1-3 wherein the bar is placed on the base in the step of heat treatment, it has been demonstrated that the distribution of coating film thickness immediately after production is satisfactory, but it is adversely affected after one-year use, as shown by the sample No. 103. This has proven the validity of the present invention.

### Example 2

<Photosensitive Layer Coating Solution>

The photosensitive layer coating solution prepared in the first example was used.

<Surface Protective Layer Coating Solution>

The surface protective layer coating solution prepared in the first example was used.

<Production of Die Coater>The extrusion type die coaters shown in FIG. 2 were manufactured according to the following method, and were assigned with “2-1” and “2-2”. The bars, made of stainless steel (SUS 630) constituting the extrusion die coater, each having a length of 4,000 mm on the long side are suspended as shown in FIG. 6, and were high-treated. Subsequent to the first grinding step for removing strain resulting from heat treatment, the bars were subjected to second grinding where they were finished into a final profile, whereby an extrusion type die coater was manufactured by assembling. Grinding was conducted under the same conditions, except that heat treatment was conducted with the bars placed on the base (upright on the base, with the reverse side of the extrusion type die coater facing downward), instead of being suspended. Another extrusion type die coater was manufactured by assembling. This is assigned with 2-3 for comparison.

Heat treatment in the heat treatment furnace was carried out at a temperature of 400 degrees Celsius for five hours. In the second grinding step, the bar was assembled to manufacture a slide type die coater. In this case, the straightness of the portion of the bar constituting the pocket section, coating solution supply port, slit section, edge, lip and slide surface was 2 μm, with a surface roughness Ra of 0.1 μm and Rmax of 0.5 μm. In the first and second grinding steps, a column type precision surface grinding machine by Okamoto Machine Tool was used. To measure the straightness, the bar was placed on the surface grinding machine, and the surface grinding machine was moved, with the probe of the dial gauge fixed in contact with the measuring point of the bar, whereby the straightness was measured. The surface roughness Ra and Rmax were measured by Model Surtest SJ-201P of Mitsutoyo Co., Ltd.

TABLE 3

| Extrusion | | |
|---|---|---|
| die coater | Position of bars | |
| No. | during heat treatment | Remarks |
| 2-1 | Suspended as shown in FIG. 7 (a) | Present |
| | | invention |
| 2-2 | Suspended as shown in FIG. 7 (b) | Present |
| | | invention |
| 2-3 | Placed on the base | Comparison |

<Coating>

The viscosity of the photosensitive layer coating solution prepared in the aforementioned steps was adjusted to 0.5 Pa·s, and the viscosity of the surface protective layer was adjusted to 1.0 Pa·s. Ten belt-shaped support members (made of PET), each having a thickness of 175 μm, a width of 4100 mm and a length of 1,000 m, were connected with one another. In a coating apparatus equipped with the extrusion type die coaters 2-1, 2-2 and 2-3 having been just produced, the belt-shaped support member held by the back roll was coated and dried under the conditions of a coating width of 3900 mm at a coating speed of 30 m/min, wherein the lower layer was provided with 75 g/m² of photosensitive layer, and the upper layer was provided with 25 g/m² of protective layer. Then samples 201 through 203 were produced. In another coating apparatus equipped with extrusion type die coaters 2-1 through 2-3 having been used for one year, the belt-shaped support member held by the back roll was coated and dried under the conditions of a coating width of 3900 mm at a coating speed of 30 m/min, wherein the lower layer was provided with 75 g/m² of photosensitive layer, and the upper layer was provided with 25 g/m² of protective layer. Then samples 204 through 206 were produced. Viscosity was obtained by measuring the viscosity for each shearing, using Model RotoVisco RV-12 by HAAKE Inc. The photosensitive layer coating solution and surface protective layer coating solution were coated at a normal temperature.

<Evaluation>

The samples 201 through 206 having been produced in the aforementioned steps were tested to measure the crosswise distribution of coating film thickness. Table 4 shows the result of this measurement. The crosswise distribution of coating film thickness was evaluated and measured according to the same steps and criteria as those in the first example.

TABLE 4

| | Crosswise distribution | | |
|---|---|---|---|
| Slide type | of coating film thickness | | |
| die coater | Immediately after | After one-year | |
| No. | production | use | Remarks |
| 2-1 | Sample No. 201 | Sample No. 204 | Present |
| | A | A | invention |
| 2-2 | Sample No. 202 | Sample No. 205 | Present |
| | A | B | invention |
| 2-3 | Sample No. 203 | Sample No. 206 | Comparison |
| | A | D | |

In the extrusion type die coater 2-3 wherein the bar is placed on the base in the step of heat treatment, it has been demonstrated that the distribution of coating film thickness immediately after production is satisfactory as shown by the sample No. 203, but it is adversely affected after one-year use, as shown by the sample No. 206. This has proven the validity of the present invention.

### Example 3

<Photosensitive Layer Coating Solution>

The photosensitive layer coating solution prepared in the first example was used.

<Surface Protective Coating Solution>

The surface protective coating solution prepared in the first example was used.

<Production of Die Coater>

When manufacturing the slide type die coater 1-1 in the first example, the straightness of all the surfaces of the bars in the second grinding step was changed to the value given in Table 5. Then the bars were assembled to manufacture the slide type die coaters. They are assigned with 3-1 through 3-7.

TABLE 5

| Slide die | Straightness |
|---|---|
| coater No. | (μm) |
| 3-1 | 0.08 |
| 3-2 | 0.1 |
| 3-3 | 1.0 |
| 3-4 | 4.0 |
| 3-5 | 7.0 |
| 3-6 | 10.0 |
| 3-7 | 11.0 |

<Coating >

The photosensitive layer coating solution prepared in the aforementioned step was coated to the slide type die coaters 3-1 through 3-7 having been just manufactured, and was dried under the same conditions as those used in the first example, whereby samples 301 through 307 were produced.

<Evaluation>

Table 6 shows the result of measuring the crosswise distribution of coating film thickness. The crosswise distribution of coating film thickness was evaluated and measured according to the same steps and criteria as those in the first example.

TABLE 6

| | Crosswise distribution | | |
|---|---|---|---|
| Slide type | of coating film thickness | | |
| die coater | Immediately after | After one-year | |
| No. | production | use | Remarks |
| 3-1 | Sample No. 301 | Sample No. 308 | Present |
| | A | A | invention |
| 3-2 | Sample No. 302 | Sample No. 309 | Present |
| | A | A | invention |
| 3-3 | Sample No. 303 | Sample No. 310 | Present |
| | A | A | invention |
| 3-4 | Sample No. 304 | Sample No. 311 | Present |
| | A | A | invention |
| 3-5 | Sample No. 305 | Sample No. 312 | Present |
| | A | A | invention |
| 3-6 | Sample No. 306 | Sample No. 313 | Present |
| | A | B | invention |
| 3-7 | Sample No. 307 | Sample No. 314 | Present |
| | A | C | invention |

The validity of the present invention has been proven.

### Example 4

<Photosensitive Layer Coating Solution>

The photosensitive layer coating solution prepared in the first example was used.

<Surface Protective Coating Solution>

The surface protective coating solution prepared in the first example was used.

<Production of Die Coater>

When manufacturing the extrusion type die coater 2-1 in the second example, the straightness of all the surfaces of the bars in the second grinding step was changed to the value given in Table 7. Then the bars were assembled to manufacture the extrusion type die coaters. They are assigned with 4-1 through 4-7.

TABLE 7

| Extrusion die | Straightness |
|---|---|
| coater No. | (μm) |
| 4-1 | 0.08 |
| 4-2 | 0.1 |
| 4-3 | 1.0 |
| 4-4 | 4.0 |
| 4-5 | 7.0 |
| 4-6 | 10.0 |
| 4-7 | 11.0 |

<Coating>

The photosensitive layer coating solution prepared in the aforementioned step was coated to the extrusion type die coaters 4-1 through 4-7 having been just manufactured, and was dried under the same conditions as those used in the first example, whereby samples 401 through 407 were produced. Further, the extrusion type die coaters 4-1 through 4-7 having been used for one year were used to coat and dry the solution under the same conditions as those of the first example, whereby samples 408 through 414 were manufactured.

<Evaluation>

Table 8 shows the result of measuring the crosswise distribution of coating film thickness. The crosswise distribution of coating film thickness was evaluated and measured according to the same steps and criteria as those in the first example.

TABLE 8

| | |
|---|---|
| | Crosswise distribution |
| Extrusion | of coating film thickness |

| type die | Immediately after | After one-year | |
|---|---|---|---|
| coater No. | production | use | Remarks |
| 4-1 | Sample No. 401 | Sample No. 408 | Present |
| | A | A | invention |
| 4-2 | Sample No. 402 | Sample No. 409 | Present |
| | A | A | invention |
| 4-3 | Sample No. 403 | Sample No. 410 | Present |
| | A | A | invention |
| 4-4 | Sample No. 404 | Sample No. 411 | Present |
| | A | A | invention |
| 4-5 | Sample No. 405 | Sample No. 412 | Present |
| | A | A | invention |
| 4-6 | Sample No. 406 | Sample No. 413 | Present |
| | A | B | invention |
| 4-7 | Sample No. 407 | Sample No. 414 | Present |
| | A | C | invention |

The validity of the present invention has been proven.

What is claimed is:

1. A method for manufacturing a die coater comprising:
a pocket section for spreading a coating solution across the coating width;
a coating solution supply port for supplying said coating solution to said pocket section; and
a slit section for discharging the coating solution from said pocket section to an object to be coated;
wherein said die coater incorporates at least two bars, and said bars are suspended with the end face of one of them facing upward; said die coater further characterized in that, after having been heat-treated in a heat treating furnace, said bars are assembled, whereby the die coater is manufactured.

2. The method for manufacturing a die coater described in claim 1 wherein said step of grinding includes the process of finish-grinding to get a final profile.

3. The method for manufacturing a die coater described in claim 2 wherein said finish-grinding is carried out in such a way that the straightness across the coating width on the position constituting the slit section is 10 μm or less, when a die coater is manufactured by assembling the bars.

4. The method for manufacturing a die coater described in claim 1 wherein said heat treatment is performed at a temperature lower than the melting point of the bar material.

5. The method for manufacturing a die coater described in claim 1 wherein said bars are constituent members of the die coater; the gap of at least one slit section comprising at least two bars is narrower on the outlet side of the coating solution than on the inlet side; and the gap d on the outlet side is d≦5×10⁻⁵ [m]; said die coater further characterized in that the coating solution is jetted at a predetermined interval in the form of a film from the slit section to the support member installed or conveyed without contacting the outlet of the slit section, whereby coating is conducted by collision.

6. The method for manufacturing a die coater described in claim 1 wherein said bars are constituent members of an extrusion type die coater; a coating solution is discharged from at least one slit section comprising at least two bars to the support member; and beads of coating solution are formed between the support member and the vicinity of the coating solution outlet of the slit, whereby coating is conducted.

7. The method for manufacturing a die coater described in claim 1 wherein said bars are constituent members of a slide type die coater; a coating solution is discharged from at least one slit section comprising at least two bars to the support member; and the discharged coating solution is fed down the slope connected to the slit outlet; said die coater further characterized in that beads of coating solution are then formed between the support member and the vicinity of the tip of the slope, whereby coating is conducted.

8. The method for manufacturing a die coater described in claim 1 wherein said bars are constituent members of a curtain type die coater, and a coating solution flowing out of at least one slit section comprising at least two bars is subjected to a free fall down to the support member, whereby coating is conducted.

9. The method for manufacturing a die coater described in claim 1 wherein said bars are constituent members of the die coater having a coating width of 1 m or more.

10. The method for manufacturing a die coater described in claim 9 wherein said die coater has a coating width of 1 m through 4 m.
